(19) United States
(12) Patent Application Publication
(10) Pub. No.: US 2003/0163956 A1
(43) Pub. Date: Sep. 4, 2003

(54) Watering device

(76) Inventor: Andrew Staples, Victoria (AU)

Correspondence Address: SMITH-HILL AND BEDELL, 12670 N W BARNES ROAD, SUITE 104, PORTLAND, OR, 97229

(21) Appl. No.: 10/376,950

(22) Filed: Feb. 27, 2003

(30) Foreign Application Priority Data
Mar. 1, 2002 (AU) PS0892

(51) Int. Cl. A01G 29/00

(52) U.S. Cl. 47/48.5

(57) ABSTRACT

A watering tube 10 300-400 mm long is insertable at the drip line of a shrub by mounting the tube on the leading end of a driver. The driver and tube are driven into the ground using a sinking hammer 16. The tube has an internal wall taper to permit easy separation of the driver from the tube 10 after sinking.

The driver 2 is hollow with a swaged entry end 6 allowing the plug of soil produced by insertion to rise up the driver.

The driver has a lever-operated retractor 20-36 which reacts against the top 12 of the sunken tube and separates the driver from the tube.

### FIELD OF THE INVENTION

This invention concerns subterranean watering tubes for plants and devices for installing them.

### BACKGROUND OF THE INVENTION

In dry climates watering of gardens and parks is necessary if expensive garden or park plant investments, in trees or shrubs, are to survive. Watering by fixed system or hand watering commonly relies on surface sprinkling. Much water is lost by this method, as the garden or park does not utilize water efficiently, in that it is not evident, when sprinkling, where the water is penetrating in sufficient quantity to reach the root systems of the trees or shrubs. If subterranean water is supplied at the drip line, by sinking watering tubes into the soil, then severe water deprivation can be prevented. Park keepers, landscapers and professional gardeners sometimes install plastic pipes at the drip line of the plant when new planting is being undertaken. This ensures that if the water is fed into the plastic pipe then it must go to the root system of the new planting. Currently the retrofitting of a plastic pipe, at the drip line of established trees or shrubs, is usually avoided because of the amount of work, and ground disturbance required. To install a plastic pipe 300 or 400 mm deep is usually not feasible because of the possible obstacle it poses for cultivation or lawn mowing operations.

Gardeners find that if subterranean water is supplied at the drip line by sinking watering tubes in the soil, even severe water deprivation can be rectified. The tubes for this purpose must be 300-400 mm long but inserting these would require purpose built components if the ground disturbance is to be minimised.

GB 453 429 describes a conical tube for inserting in the soil next to a plant for ensuring a supply of water close to the plant roots. The tube is inserted by applying the tube to a tapered dibber which is thrust into the soil and then withdrawn leaving the tube buried.

U.S. Pat. No. 3,916,564 carries this idea further by the provision of a hose coupling to the exposed end of the sunken tube allowing a prolonged supply of water.

U.S. Pat. No. 5,692,338 added perforations to the watering tube throughout the length of the tube.

Tubes to be inserted at the drip line of previously established shrubs and trees need insertion by a driver. Extruded plastic tubes are commonly out of round and using a slide fit pole to sink them introduces problems. The use of a solid driver also introduces problems. Separation of the driver from the buried tube creates delays because soil particles jam the driver in the tube. Progress is faster if the driver is hollow, but the soil plug must not obstruct the hollow interior or further delay will result.

### SUMMARY OF THE INVENTION

One apparatus aspect of the invention provides a plastic watering tube for sinking into the ground, capable of being mounted on the leading end of another apparatus aspect of the invention, named the insertion driver apparatus. The watering tube has a leading end and a trailing end, the wailing end being of somewhat larger internal diameter than the internal diameter of the leading end, which assists in the separation of the driver from the tube when retracting the driver. Even a small taper will assist in the extraction. Tapers of 0.5-2:100 are useful and we prefer 1:100. This counteracts the jamming effected soil particles driven between the tube and the driver. The tube may be an injection moulding, of any diameter; of the same or similar polymer used for agricultural subterranean pipes. The tailing end may be closed by a cap, which covers 15 mm to 25 mm of the tube.

The tube may be an injection moulding, of the same polymer used for agricultural subterranean pipes, 50-65 mm in diameter. The trailing end may be closed by a cap which covers 15-25 mm of the trailing end of the tube. The cap may have a baffle to prevent ingress of stones, snakes and other fauna, but would still allow for water entry.

Another apparatus aspect of the invention is the insertion driver. The insertion driver may be hollow and made of steel with a leading end and a trailing end. The leading end may be somewhat reduced in cross-section, for example by swaging or crimping, in order to present an internal expanding pathway for the rising plug of soil that is to be removed from the trailing end of the driver after each insertion. The driver may have a top flange positioned along its length for taking the impact of a purpose made sinking hammer or a standard star picket hammer. The driver may have a bottom flange for contacting the trailing end of the plastic watering tube. The term “flange” is used to describe the impacting parts of the driver. Clearly, any similar structural extension from the cylindrical body of the driver will perform an equivalent function. The driver may have an extraction device located towards the leading end.

### BRIEF DESCRIPTION OF THE DRAWINGS

An embodiment of the invention is now described by way of example with reference to the accompanying drawings, in which:

FIG. 1 is a side view of the driver driving a tube into the ground.

FIG. 2 is a side view of the driver being withdrawn.

FIG. 3 is a side view of the watering tube on the end of a driver ready for insertion.

FIG. 4 is the trailing end of the tube of FIG. 3 with a cap.

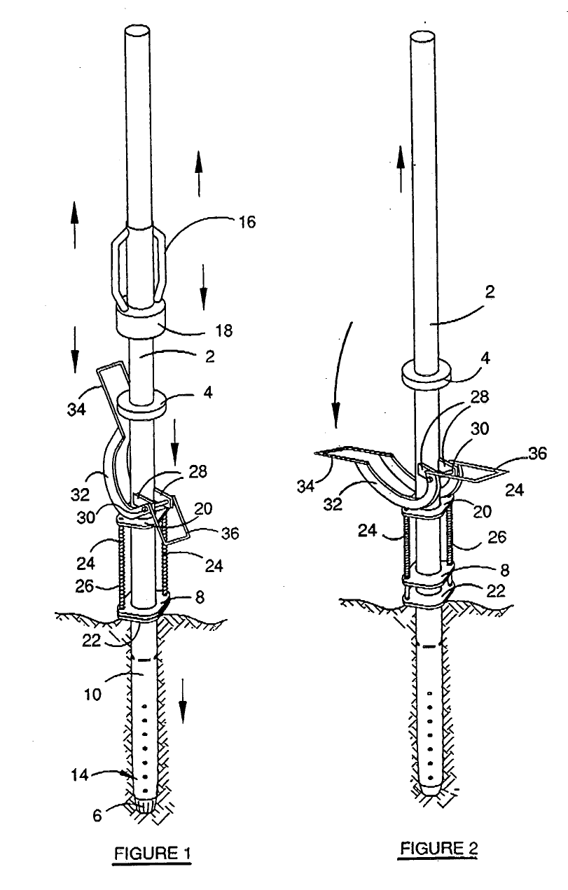

### DETAILED DESCRIPTION WITH RESPECT TO THE DRAWINGS

The driver 2 is a steel tube 1600×48.3ø with 100 mm striker flange 4 welded at 750 mm. The leading end 6 of the driver is swaged to a smaller diameter to allow the plugs of soil generated by sinking to be shaken out. The driver has a tube flange 8 welded to the driver to stop the tube 10 from sliding up the driver shaft.

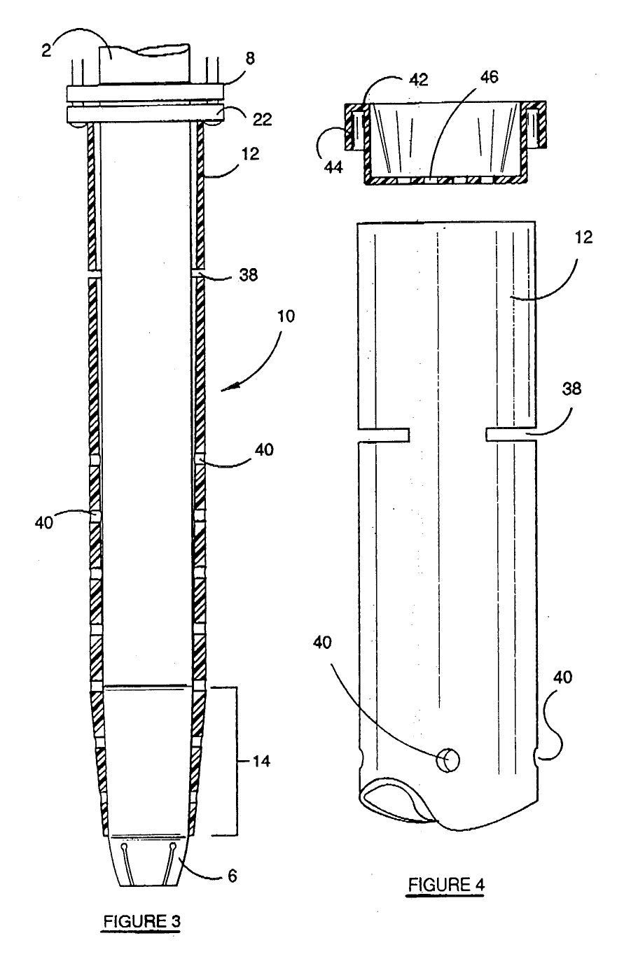

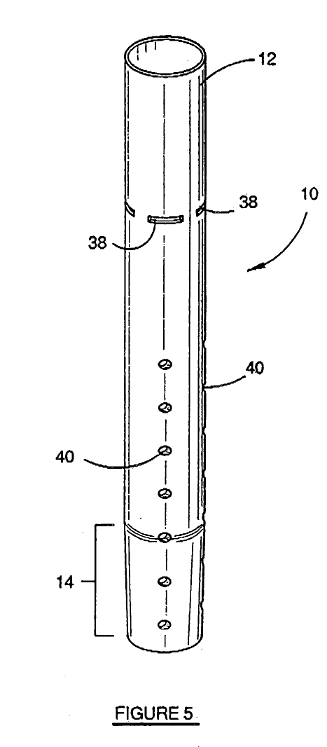

In FIG. 3 the driver is seen projecting through the tube 10 so that the driver cuts a hole in the soil and the tube 10 follows it. The tube flange and the lower extraction flange 22 impact on the trailing end 12 of the tube. The tube is tapered internally being slide fit at the swaged end 6 of the driver and a looser fit (4 mm larger) at the trailing end 12. This allows the driver 2 to be easily withdrawn after insertion. The leading end 14 of the tube is chamfered over 75 mm to ease insertion and create an interference fit for the tube.

The tube outer surface above the chamfer is cylindrical, ie. of constant diameter.

A sinking hammer 16 is 750 mm long and modified by placing a heavy, annular striker boss 18 adjacent the striker flange 4. The upper end of the striker is open. Impacts on the striker flange 4 are transmitted to the tube flange and the lower extraction flange 22.

In FIG. 3 the driver 2 is seen projecting past the end of tube 10 allowing the driver to punch a hole in the soil followed by the tube. The tube flange and the lower extraction flange impacts on the tube. After the tube is inserted in the soil to the required depth, the driver must be extracted ready for the next insertion. The trailing end of the tube offers a convenient reaction surface for the extractor mechanism. The mechanism has an upper flange 20 and a lower flange 22 which are coupled by guide rods 24. The rods ride in bores in the tube flange 8. Coil springs 26 fitted over the guide rods 24 and trapped between the tube flange 8 and the upper flange 20 hold the lower flange against the underside of the tube flange 8.

An abutment 28 is welded to the driver wall. The abutment mounts a fulcrum pin 30. The pin supports a pair of C-shaped cams 32 which straddle the driver and are joined at both ends by a U-shaped handle 34, 36. The lower edge of cams 32 bear against upper flange 20 and move the flanges 20 and 22 as a pair. Downward manual pressure on the upper handle and upward pressure on the lower handle imposes a lifting force on the drive separating it from the tube. The driver drives 50 mm deeper than the tube. The driver is zinc plated.

Referring now to FIG. 3, the tube is an injection moulding in agricultural grade plastic with an uneven wall thickness. A set of slots 38 are arranged regularly around the circumference 100 mm from trailing end 12. Round perforations 40 at 30 mm intervals occupy the main part of the tubes. The end most 75 mm 14 of the outer surface of the tube is chamfered to assist sinking and make the tube a tight fit in the hole in the &round. The external diameter of the tube between 12 and above 14 is cylindrical, ie. of constant diameter. The tube is tapered internally, being a slide fit on the driver at the swaged end and a looser fit (4 mm larger) at trailing end 12. This design feature greatly assists in the insertion when the leading end of the tube is supported adequately and in retraction when the driver retreats into an area of increasing clearance. The 400 mm tube may easily be shortened by 100 mm by sawing through tie tube wall separating adjacent slots 38 or sawing elsewhere to the required length after insertion.

FIG. 5 the perforations 40 are evident. The cap 42 is made of UV stable polymer with a collar 44 to cover the end of the tube which would otherwise be exposed. The cap has a perforated baffle 46 which allows a hose to direct water down the tube. After sinking, the driver is inverted and the soil plug is tipped out before the next insertion.

In other embodiments the taper is 0.6, 0.7, 0.8, 0.9, 1.0, 1.1, 1.2, 1.3, 1.4, 1.5, 1.6, 1.7, 1.8, 1.9, 2.0:100.

We have found the advantages of the above embodiment to be:

1. Sinking is easy and rapid because the force of the striker is efficiently applied.

2. Retraction of the striker is easy because the taper of the tube reduces the friction caused by trapped soil particles.

3. Retraction of the striker is lever assisted.

4. The length of the tube is adjustable before insertion for new plantings and after for existing plantings.

Those persons such as contractors and tradespeople will appreciate that the driver is useful for sinking components other than watering tubes, eg. sockets for signs, flagpoles and temporary or removable barriers.

What is claimed is:

1. A watering tube capable of being mounted on the parallel sided leading end of a driver for sin in the ground, the tube having a leading end and a trailing end, an outer wall and an inner wall, the inner wall being tapered in a direction which assists separation from the driver on retraction of the driver.

2. A tube as claimed in claim 1, wherein the outer wall is cylindrical.

3. A tube as claimed in claim 1, wherein the outer wall is tapered in a direction which assists sinking.

4. A tube as claimed in claim 2, wherein the outer wall of the leading end of the tube is chamfered.

5. A tube as claimed in claim 1, wherein the internal taper is at least 0.5-2:100.

6. A tube as claimed in claim 4, wherein the chamfer extends over 50-100 mm.

7. A tube as claimed in claim 1, having a series of water release aperture at increasing depth.

8. A tube as claimed in claim 1, wherein a line of weakness is located in the trailing half of the tube which allows the tube to be easily shortened.

9. A tube as claimed in claim 1, wherein the tube has a cap made of uv resistant polymer with perforations for admission of hose water.

10. A moulded tube for directing water to the roots of a plant, having an inner wall and an outer wall with a trailing end and a leading end for sinking in the ground, the inner wall being tapered such that the size of the inner wall at the trailing end is larger than the size of the inner wall at the leading end, the length of the tube being from 300-500 mm.
